(19) United States
(12) Patent Application Publication
(10) Pub. No.: US 2025/0219459 A1
(43) Pub. Date: Jul. 3, 2025

(54) METHOD OF FOREIGN OBJECT DETECTING DURING WIRELESS POWER TRANSFER AND POWER TRANSMITTER IN WIRELESS CHARGING SYSTEM

(71) Applicant: Delta Electronics, Inc., Taoyuan City (TW)

(72) Inventors: YOU JHIH JHENG, Taoyuan City (TW); RI LONG LO, Taoyuan City (TW); LO YUN SUN, Taoyuan City (TW); CHIH WEI LIU, Taoyuan City (TW)

(21) Appl. No.: 18/634,906

(22) Filed: Apr. 13, 2024

(30) Foreign Application Priority Data
Jan. 3, 2024 (CN) 202410012322.1

(51) Int. Cl. H02J 50/60; G01V 3/10; H02J 50/12

(52) U.S. Cl. CPC H02J 50/60; G01V 3/101; H02J 50/12

(57) ABSTRACT

A method of foreign object detecting during wireless power transfer and a power transmitter are provided. The power transmitter includes: a control circuit, configured to temporarily interrupt transmission of an electricity signal; a signal sampling circuit, configured to sample, during the transmission of the electricity signal is temporarily interrupted, a signal generated by an oscillation circuit of the power transmitter; the control circuit is further configured to: obtain an oscillation waveform based on sampled values; perform an integral operation on the oscillation waveform and average the result of the integral operation to obtain an integrated average value; obtain an oscillation frequency of the oscillation waveform; and determine whether there is a foreign object based on the integrated average value and the oscillation frequency. The power transmitter can effectively improve the accuracy of determining whether there is a foreign object approaching the power transmitter during the wireless power transfer.

### CROSS REFERENCE TO RELATED APPLICATION

This application claims priority to China Patent Application No. 202410012322.1, filed on Jan. 3, 2024, which is incorporated herein by reference in its entirety.

### TECHNICAL FIELD

Embodiments of the present application relate to a wireless charging system, and more particularly to a method of detecting whether there is a foreign object approaching a power transmitter in a wireless charging system during wireless power transfer, and a power transmitter.

### BACKGROUND

In wireless charging systems, a power transmitter (or TX) conveys electric energy to a power receiver (or RX) placed on or close to the power transmitter by electromagnetic waves to charge or supply power to the power receiver. In this process, a coil of the power transmitter has an oscillation frequency as the same as or similar to that of the coil of the power receiver such that they can be effectively coupled to each other. Energy can be effectively propagated therebetween even if they are separated by a certain distance or there is a non-metallic object placed therebetween.

If a metal object is placed close to the power transmitter and receiver during the power transmitter supplies power to the power receiver, the power transmitter, the power receiver and the metal object may be damaged by the heat generated by the metal object.

In existing wireless charging systems, Q factor is based in determining whether there is a foreign object (FO), e.g., a metal foreign object. The Q factor is a characteristic parameter of an oscillation circuit of the power transmitter. The value of Q factor resulted when there is a metal foreign object will be different from the value of Q factor resulted when there is no metal foreign object. Therefore, the Q factor can be based in determining whether there is a metal foreign object. FIG. 1A and FIG. 1B illustrate oscillation waveforms of the oscillation circuit of the power transmitter obtained when there is no metal foreign object and when there is a metal foreign object, respectively. As shown in FIG. 1A and FIG. 1B, when there is a metal foreign object, the amplitude of the oscillation waveform will drop rapidly, and the value of Q factor corresponding thereto will also be smaller than the value of Q factor resulted when there is no metal foreign object.

A conventional method to calculate the Q factor is to capture signal peaks V1 and V2 corresponding to two time points respectively and use the frequency of the captured signal to do calculations to obtain the value of Q factor. However, in this method, once the signal peak V1 or V2 is interfered by noise or a deviation on extracted values occurs, a distortion will be caused for the calculated value of Q factor, which may easily cause a misjudgment on the presence of a metal foreign object.

### SUMMARY

The embodiments of the present application provide a detecting method and a power transmitter, which can effectively improve the accuracy of determining whether there is a foreign object approaching the power transmitter in a wireless charging system during wireless power transfer. The technical solutions provided in the present application are described below.

According to an aspect of embodiments of the present application, a detecting method is provided for detecting whether there is a foreign object approaching a power transmitter in a wireless charging system during the power transmitter supplies power electricity, the method including: utilizing a control circuit to temporarily interrupt transmission of an electricity signal to a power receiver of the wireless charging system; utilizing a signal sampling circuit to sample, during the transmission of the electricity signal is temporarily interrupted, a signal generated by an oscillation circuit of the power transmitter; utilizing the control signal to obtain an oscillation waveform based on sampled values obtained by sampling the signal by the signal sampling circuit; utilizing the control circuit to perform an integral operation on the oscillation waveform and average the result of the integral operation to obtain an integrated average value; obtaining an oscillation frequency of the oscillation waveform; and determining whether the foreign object exists, based on the integrated average value and the oscillation frequency.

According to another aspect of embodiments of the present application, a power transmitter in a wireless charging system is provided, the power transmitter including: a control circuit, configured to temporarily interrupt transmission of an electricity signal to a power receiver of the wireless charging system; and a signal sampling circuit, coupled to the control circuit, configured to sample, during the transmission of the electricity signal is temporarily interrupted, a signal generated by an oscillation circuit of the power transmitter, wherein the control circuit is further configured to: obtain an oscillation waveform based on sampled values obtained by sampling the signal by the signal sampling circuit; perform an integral operation on the oscillation waveform and average the result of the integral operation to obtain an integrated average value; obtain an oscillation frequency of the oscillation waveform; and determine whether there is a foreign object approaching the power transmitter, based on the integrated average value and the oscillation frequency.

The technical solutions provided in the embodiments of the present application may achieve beneficial effects as follows.

In the detecting method and the power transmitter of the embodiments of the present application, transmission of an electricity signal from the power transmitter to the power receiver of the wireless charging system is temporarily interrupted during wireless power transfer, and a damped oscillation waveform generated by the oscillation circuit of the power transmitter is sampled during the transmission of the electricity signal is temporarily interrupted. An integral operation is performed on the sampled oscillation waveform to obtain the integrated average value, and an estimation is conducted to obtain the oscillation frequency of the oscillation waveform. Then, the integrated average value and the oscillation frequency are based in determining whether there is a foreign object approaching the power transmitter, during the power transmitter supplies power electricity. Different from the conventional method, i.e., calculating a value of Q factor of the oscillation waveform, the present application can improve the conventional method in which the accuracy of the value of Q factor is affected by interference by noise or a deviation on extracted values, and this causes a problem in determining whether there is a foreign object approaching the power transmitter. Therefore, the present application can effectively improve the accuracy of determining whether there is a foreign object approaching the power transmitter during wireless power transfer.

It should be appreciated that the above generic description and the following detailed description are merely for illustrating and interpreting the present application and the present application is not limited thereto.

### BRIEF DESCRIPTION OF THE DRAWINGS

For explaining the technical solutions used in the embodiments of the present application more clearly, the figures to be used in describing the embodiments will be briefly introduced in the following. Obviously, the figures described below are only some of the embodiments of the present application, and those of ordinary skill in the art can further obtain other figures according to these figures without making any inventive effort.

FIG. 1A is a schematic diagram illustrating an oscillation waveform of an oscillation circuit of a power transmitter resulted when there is no metal foreign object.

FIG. 1B is a schematic diagram illustrating an oscillation waveform of an oscillation circuit of a power transmitter resulted when there is a metal foreign object.

FIG. 2 is a schematic block diagram of a power transmitter according to an embodiment of the present application.

FIG. 3A is a schematic diagram illustrating an example of obtaining an integrated average value according to an embodiment of the present application.

FIG. 3B is a schematic diagram illustrating another example of obtaining an integrated average value according to an embodiment of the present application.

FIG. 3C is a schematic diagram illustrating an example of obtaining an oscillation frequency according to an embodiment of the present application.

FIG. 4A is a schematic diagram illustrating an oscillation waveform measured when no foreign object is detected during wireless power transfer according to an embodiment of the present application.

FIG. 4B is a schematic diagram illustrating an oscillation waveform measured when a foreign object is detected during wireless power transfer according to an embodiment of the present application.

FIG. 5 is a diagram showing a comparison of oscillation waveforms resulted when there is a foreign object and when there is no foreign object according to an embodiment of the present application.

FIG. 6 is a flowchart of a detecting method according to an embodiment of the present application.

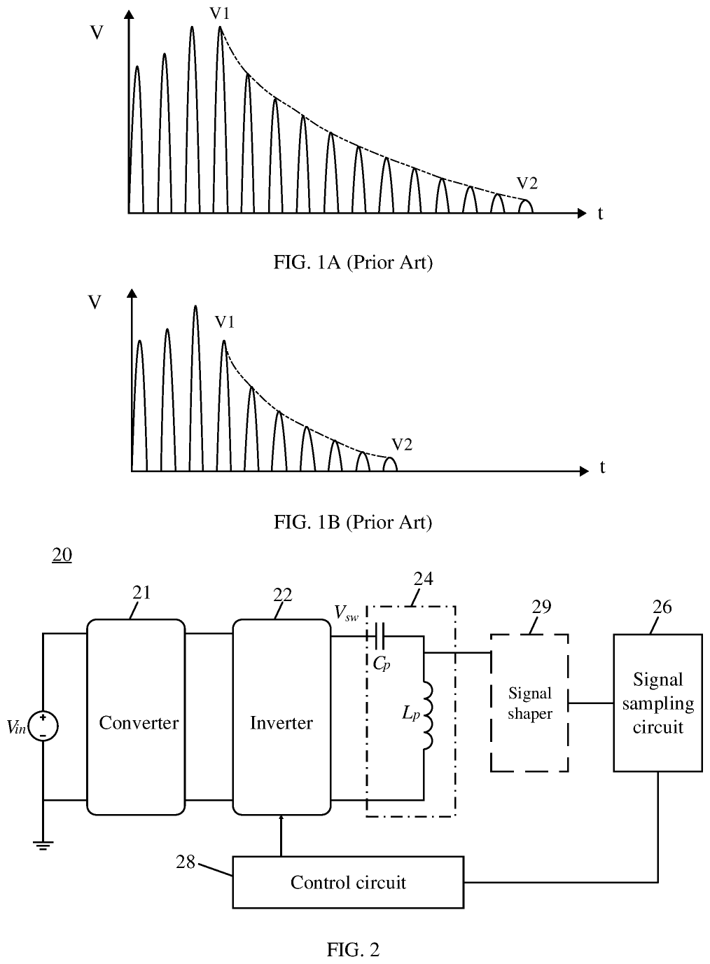

### DETAILED DESCRIPTION

The technical solutions in the embodiments of the present application will be clearly and completely described below with reference to the figures of the embodiments of the present application. Obviously, the described embodiments are merely a part of embodiments of the present application and are not all of the embodiments. Based on the embodiments of the present application, all the other embodiments obtained by those of ordinary skill in the art without making any inventive effort are within the scope sought to be protected in the present application.

Generally, a wireless charging system includes a power transmitter (or TX) and one or more power receivers (or RX). The power transmitter can be used to wirelessly supply power to the power receiver(s) to charge or power the power receiver(s). The concept of invention provided in this application is mainly for detecting whether there is a foreign object (FO) approaching the wireless charging system during the power transmitter supplies power electricity to the power receiver. for example, to determine if a foreign object is placed on or close to the power transmitter. The foreign object mentioned in the present application refers to an object made of or containing a metal material, or a composite material, a mixture and an alloy, etc., which will be affected by wirelessly-transmitted electromagnetic waves. The foreign object may also have a coil or may be a coil-like object. If a foreign object is detected, the power transmitter may stop supplying power to the power receiver.

For an oscillation waveform generated by an oscillation circuit of the power transmitter, different from the traditional method, i.e., calculating a value of Q-factor of the oscillation waveform, in the embodiments of the present application, an integral operation and an average operation are performed on the oscillation waveform to obtain an integrated average value, and an estimation is conducted to obtain an oscillation frequency of the oscillation waveform. Then, based on the integrated average value and the oscillation frequency, it is achieved a determination on whether there is a foreign object approaching the power transmitter during wireless power transfer. In this way, the present application can improve the conventional method in which the accuracy of the value of Q factor is affected by interference by noise or a deviation on extracted values, and this causes a problem in determining whether there is a foreign object approaching the power transmitter.

Specifically, an embodiment of the present application provides a method of foreign object detection, which includes temporarily interrupting transmission of an electricity signal to a power receiver of the wireless charging system; sampling, during the transmission of the electricity signal is temporarily interrupted, a signal generated by an oscillation circuit of the power transmitter; obtaining an oscillation waveform based on sampled values obtained by sampling the signal by the signal sampling circuit; performing an integral operation on the oscillation waveform and averaging the result of the integral operation to obtain an integrated average value; obtaining an oscillation frequency of the oscillation waveform; and determining whether there is a foreign object approaching the power transmitter, based on the integrated average value and the oscillation frequency.

Specifically, an embodiment of the present application provides a power transmitter, which includes a control circuit, configured to temporarily interrupt transmission of an electricity signal to a power receiver of the wireless charging system; and a signal sampling circuit, coupled to the control circuit, configured to sample, during the transmission of the electricity signal is temporarily interrupted, a signal generated by an oscillation circuit of the power transmitter, wherein the control circuit is further configured to: obtain an oscillation waveform based on sampled values obtained by sampling the signal by the signal sampling circuit; perform an integral operation on the oscillation waveform and average the result of the integral operation to obtain an integrated average value; obtain an oscillation frequency of the oscillation waveform; and determine whether there is a foreign object approaching the power transmitter, based on the integrated average value and the oscillation frequency.

FIG. 2 is a schematic block diagram of a power transmitter 20 according to an embodiment of the present application. The power transmitter 20 includes a converter 21, an inverter 22, an oscillation circuit 24, a signal sampling circuit 26 and a control circuit 28 and optionally includes a signal shaper or proportional voltage divider 29. The converter 21, the inverter 22 and the oscillation circuit 24 are well known to a person of ordinary skill in the art. Therefore, a detailed description on these components is not necessary. The capturing of a damping oscillation waveform generated by the oscillation circuit 24 can be conducted at any node of a loop with the oscillation circuit 24 and is not limited to the node between a capacitor Cₚ and an inductor Lₚ shown in FIG. 2. The oscillation waveform captured by the signal sampling circuit 26 can be stored in a buffer (not shown) for later processing. The control circuit 28 processes the stored oscillation waveform data to obtain an integrated average value and an oscillation frequency. Based on the obtained integrated average value and the oscillation frequency, the control circuit 28 can make a decision as to whether there is a foreign object approaching the power transmitter 20.

The converter 21 can perform an appropriate voltage conversion on a direct-current (DC) input voltage Vᵢₙ. The voltage or current output to a load (not shown, e.g., a power receiver) may mainly depend on the conversion conducted by the converter 21. The converter 21 may be a buck converter, which can output a suitable DC voltage to the inverter 22.

The inverter 22 is configured to convert the DC input voltage Vᵢₙ into an oscillated inverter output waveform (V_{sw}) for driving the oscillation circuit 24. For example, the inverter 22 may be a DC-to-AC full-bridge inverter with four transistors (not shown), or the inverter 22 may be implemented by a half-bridge inverter. The control circuit 28 can generate the inverter output waveform (V_{sw}) by controlling the switching of the transistors (not shown) in the inverter 22. The control circuit 28 can also control the inverter 22 to disconnect the inverter 22 from a power supply such that only the loop with the oscillation circuit 24 remains.

The oscillation circuit 24 includes a capacitor Cₚ and an inductor Lₚ that are connected in series with each other, but is not limited thereto. An oscillation circuit 24 consisting of two capacitors and one inductor or other types of oscillation circuits can also be used. In the wireless charging system, by a coupling between the inductor Lₚ of the oscillation circuit 24 in the power transmitter 20 and an inductor (not shown) in a power receiver, electrical power is supplied from the power transmitter 20 to the power receiver.

During wireless power transfer, i.e., the power transmitter 20 supplies power to the power receiver, the inverter 22 will persistently generate the inverter output waveform (V_{sw}), and the signal waveform output by the oscillation circuit 24 will be a signal waveform with a consistent peak voltage. The power transmitter 20 transmits electromagnetic waves with such a signal waveform to the power receiver so as to supply power to or charge the power receiver. If at the time the inverter 22 is disconnected from a power supply for a small period of time (i.e., when the transmission of the electricity signal is temporarily interrupted), the energy stops being supplied within this period of time, and the voltage amplitude of the signal waveforms measured on the oscillation circuit 24 during the transmission of the electricity signal is temporarily interrupted will gradually decrease, resulting in a damped oscillation waveform.

If there is a foreign object approaching the power transmitter 20 during the wireless power transfer, the amplitude of the oscillation waveform measured on the oscillation circuit 24 during the transmission of the electricity signal is temporarily interrupted will be attenuated significantly, and the voltage amplitude of the oscillation waveform will decrease rapidly. Therefore, a detection on the attenuation of the oscillation waveform during the transmission of the electricity signal is temporarily interrupted can be conducted so as to determine whether there is a foreign object nearby during the wireless power transfer. If there is a coil-like foreign object approaching the power transmitter 20 during the wireless power transfer, it may not have a great change of the signal amplitude of the oscillation waveform. However, the frequency of the oscillation waveform measured during the transmission of the electricity signal is temporarily interrupted may likely have a change. Therefore, a detection on the frequency of the oscillation waveform can also be conducted so as to determine whether there is a coil-like foreign object nearly.

The signal sampling circuit 26 may sample a signal (e.g., a voltage signal) generated by the oscillation circuit 24 of the power transmitter 20 during the transmission of the electricity signal is temporarily interrupted, to obtain sampled values. The above oscillation waveform is composed of these sampled values. The afore-mentioned signal sampling can be implemented by using a signal sampling circuit which is well known to a person of ordinary skill in the art. In order to detect whether there is a foreign object approaching the power transmitter during the wireless power transfer, the time the signal sampling circuit 26 conducts the sampling may be during the transmission of the electricity signal is temporarily interrupted. During the wireless power transfer, the transmission of the electricity signal can be temporarily interrupted periodically, and the signal sampling circuit 26 can capture the signals generated by the oscillation circuit 24 during these brief interruptions. During the wireless power transfer, the transmission of the electricity signal can also be interrupted on-demand so as to conduct the capturing of oscillation waveforms. The signal sampling performed by the signal sampling circuit 26 can be performed only for a period of time (which can be referred to as a signal extraction period) during the transmission of the electricity signal is interrupted.

The control circuit 28 can obtain the oscillation waveform based on the sampled values obtained by sampling the signal by the signal sampling circuit 26. The data sampled by the signal sampling circuit 26 may be stored in a buffer (not shown) in advance, and then the control circuit 28 reads the data from the buffer (not shown) to obtain the oscillation waveform. The control circuit 28 can analyze the oscillation waveform to obtain an integrated average value and an oscillation frequency corresponding to the oscillation waveform. Then, the control circuit 28 determines whether there is a foreign object approaching the power transmitter 20 based on the integrated average value and the oscillation frequency.

The control circuit 28 may analyze only an upper-half or a lower-half of the oscillation waveform to obtain the integrated average value and the oscillation frequency. Alternatively, the signal sampling circuit 26 may only sample an upper-half or a lower-half of the oscillation waveform and output the upper-half or the lower-half of the oscillation waveform to the control circuit 28 for later analysis.

Optionally, the power transmitter 20 may further include a signal shaper or a proportional voltage divider 29 for scaling down the signal generated by the oscillation circuit 24 in a certain proportion. The structure of the signal shaper 29 is well known to a person of ordinary skills in the art. If the amplitude (e.g., 100V) of the signal (e.g., voltage signal) generated by the oscillation circuit 24 is too large, the signal generated by the oscillation circuit 24 can be appropriately adjusted by using the signal shaper 29, and then the signal sampling circuit 26 performs the sampling on the adjusted signal. In this way, the requirements on signal processing capabilities of the signal sampling circuit 26 and the control circuit 28 can be effectively lowered.

The control circuit 28 may be a circuit with certain integration, which may include a control logic and a computing logic. The control logic can be used to control the actions of the inverter 22 and other electronic components of the power transmitter 20 and can also be used to control the entire charging process for a power receiver. The computing logic can be used to perform necessary processing or computations on the obtained data, and the results obtained by the computing logic can be fed back to the control logic such that the control logic can adjust the charging process.

The control circuit 28 may also include a signal processing logic, which may process the received signal in a certain level, for example, denoising, filtering or shaping of the signal. The signal sampling circuit 26 may also be integrated into the control circuit 28 as a part of the signal processing logic, thereby simplifying the entire circuit layout of the power transmitter 20. Of course, the control logic, the computing logic and/or the signal processing logic can constitute a generic control circuit 28, but these logics are dispersed in different electronic components.

During the wireless power transfer, it is possible to periodically temporarily interrupt the transmission of the electricity signal at intervals and detect whether a foreign object is approaching during the brief interruption. If something detected to be approaching the power transmitter 20 is a foreign object during the power transfer is temporarily interrupted, the power transmitter 20 may stop supplying power to the power receiver. Specifically, the oscillation circuit 24 is fed with the inverter output waveform (V_{sw}) during the wireless power transfer, and the feeding of the inverter output waveform (V_{sw}) stops during the transmission of the electricity signal is temporarily interrupted. In detail, the control circuit 28 controls the inverter 22 to persistently output the inverter output waveform (V_{sw}). However, during the transmission of the electricity signal is temporarily interrupted, the control circuit 28 disconnects the inverter 22 from a power supply for a short period of time. Furthermore, the signal sampling circuit 26 samples the signal generated by the oscillation circuit 24 during the transmission of the electricity signal is temporarily interrupted. That is, the signal sampling operation conducted by the signal sampling circuit 26 is performed after the inverter 22 is disconnected from the power supply. Further, the control circuit 28 obtains the oscillation waveform based on the sampled values obtained during the transmission of the electricity signal is temporarily interrupted. That is, the oscillation waveform obtained at the time is a damped oscillation waveform. Therefore, by analyzing the damped oscillation waveform during the transmission of the electricity signal is temporarily interrupted, the control circuit 28 can detect whether there is a foreign object approaching the power transmitter 20.

In some embodiments, the control circuit 28 obtains the integrated average value and the oscillation frequency based on a scaled-down version of the oscillation waveform. For example, the signal generated by the oscillation circuit 24 can be scaled down in a certain proportion by the signal shaper 29 and then sampled by the signal sampling circuit 26; or the signal sampling circuit 26 can scale down the sampled signal in a certain proportion; or the control circuit 28 can scale down the sampled signal received from the signal sampling circuit 26 in a certain proportion.

In some embodiments, the control circuit 28 obtains the integrated average value and the oscillation frequency based on an upper-half or a lower-half of the oscillation waveform. Specifically, the control circuit 28 analyzes the entire oscillation waveform. Alternatively, the control circuit 28 can analyze only an upper-half or a lower-half of the oscillation waveform to obtain the integrated average value and the oscillation frequency. The analysis of a partial waveform can reduce the amount of required computations and increase the speed of detection.

In some embodiments, the control circuit 28 obtains the integrated average value and the oscillation frequency based on the oscillation waveform within a signal extraction period during the transmission of the electricity signal is temporarily interrupted. Specifically, the control circuit 28 can only analyze the oscillation waveform within a period of time (which is called a signal extraction period) during the transmission of the electricity signal is interrupted, to obtain the integrated average value and the oscillation frequency so as to reduce the amount of computations.

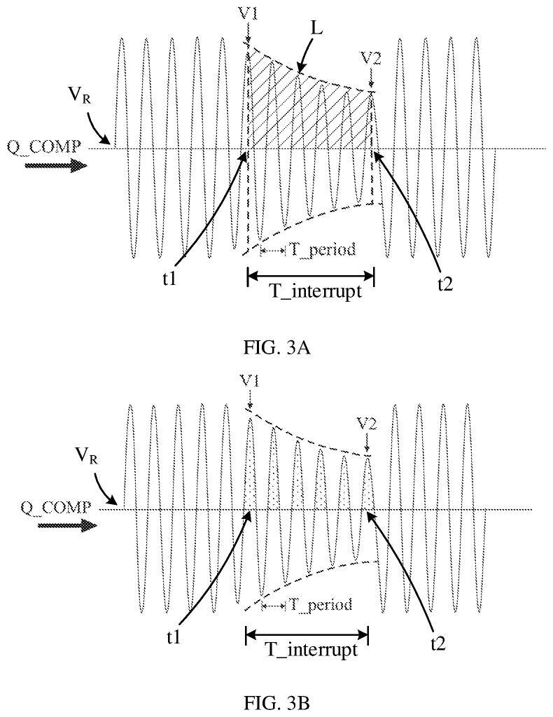

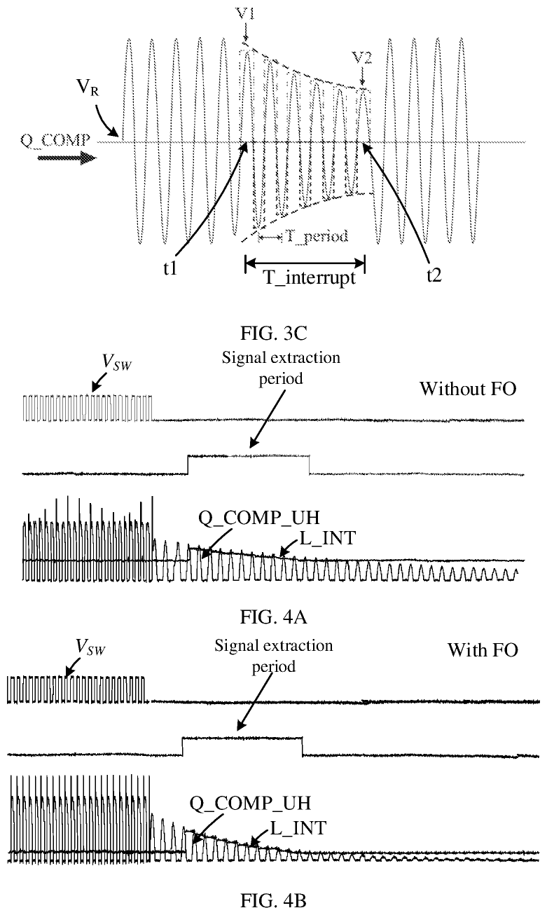

In some embodiments, referring to FIG. 3A, the oscillation waveform is indicated by Q_COMP. During the transmission of the electricity signal is temporarily interrupted (i.e., the period T_interrupt), the control circuit 28 can obtain the integrated average value by calculating an area between a peak curve L formed by a first signal peak value V1 corresponding to a first time point t1 in the oscillation waveform and a second signal peak V2 corresponding to a second time point t2 in the oscillation waveform and a reference voltage V_{R}. Specifically, the control circuit 28 obtains a first signal peak value V1 at a first time point t1 in the oscillation waveform; obtains a second signal peak value V2 at a second time point t2 in the oscillation waveform; obtains a peak curve L based on the first signal peak value V1 and the second signal peak value V2; and performs an integral operation based on the peak curve L and a reference voltage V_{R}, and averaging the result of the integral operation based on a difference between the first time point t1 and the second time point t2 to obtain the integrated average value. The peak curve L may be a curve fitted by the first signal peak value V1, the second signal peak value V2 and all of signal peak values between the first time point t1 and the second time point t2. After the peak curve L is obtained, the result obtained by performing the integral operation on the peak curve L can be represented by the area between the peak curve L and the reference voltage V_{R}. That is, the control circuit 28 obtains the area of a region between the peak curve L and the reference voltage V_{R}. After obtaining the integral result, the control circuit 28 averages the result based on time (that is, dividing the integral result by a difference between the first time point t1 and the second time point t2), thereby obtaining the integrated average value.

In other embodiments, referring to FIG. 3B, the oscillation waveform is indicated by Q_COMP. During the transmission of the electricity signal is temporarily interrupted (i.e., the period T_interrupt), the control circuit 28 can obtain the integrated average value by calculating an area between all signal waveforms between a first time point t1 and a second time point t2 in the oscillation waveform and a reference voltage V_{R}. Specifically, the control circuit 28 obtains a first time point t1 corresponding to a first signal peak value V1 in the oscillation waveform; obtains a second time point t2 corresponding to a second signal peak value V2 in the oscillation waveform; and performs an integral operation on all of signal waveforms between the first time point t1 and the second time point t2, and averages the result of the integral operation based on a difference between the first time point t1 and the second time point t2 to obtain the integrated average value. The control circuit 28 performs an integral operation on each of the signal waveforms between the first time point t1 and the second time point t2, obtains the area of a region between each signal waveform and the reference voltage V_{R}, and sums up the area of all the regions to obtain an integral result. The integral result is represented by a sum of areas between all of the signal waveforms between the first time point t1 and the second time point t2 and the reference voltage V_{R}. After obtaining the integral result, the control circuit 28 averages the result based on time (that is, dividing the integral result by a difference between the first time point t1 and the second time point t2), thereby obtaining the integrated average value.

The above integrated average value can represent a changing rate of voltage peak values (or an envelope of voltage signals) in the oscillation waveform and can represent the damping of the oscillation waveform. Therefore, it is suitable for being used to determine whether there is a foreign object approaching the power transmitter 20. Moreover, a use of the integrated average value can prevent the accuracy on determination from being affected by a deviation on extracted values of the signal peaks V1 and V2 or an interference with these values by noise.

In some embodiments, referring to FIG. 3C, during the transmission of the electricity signal is temporarily interrupted (i.e., the period T_interrupt), the control circuit 28 can obtain the oscillation frequency T period by calculating an average of time length occupied by all of signal waveforms between a first time point t1 and a second time point t2 in the oscillation waveform. Specifically, the control circuit 28 obtains a first time point t1 corresponding to a first signal peak value V1; obtains a second time point t2 corresponding to a second signal peak value V2; and sums the time occupied by each of signal waveforms between the first time point t1 and the second time point t2 and averages based on the sum, and converts the obtained result into a frequency to obtain the oscillation frequency. For example, it is assumed that the periods of signal waveforms between the first time point t1 and the second time point t2 are T1, T2, . . . , T9, respectively. Then, it can be concluded that an averaged period T_avg of these 9 signal waveforms is (T1+T2+ . . . . T9)/9. Since the frequency is a reciprocal of the period, it can be obtained that the oscillation frequency is 1/T_avg.

Referring to FIG. 4A (without FO), during the wireless power transfer, i.e., during the power transmitter 20 supplies power to the power receiver, the inverter 22 will persistently generate the inverter output waveform (V_{sw}). During the transmission of the electricity signal is temporarily interrupted, the inverter 22 is disconnected from a power supply and no longer outputs V_{sw}. It is possible to take only an upper-half of the originally obtained oscillation waveform Q_COMP to obtain a waveform Q_COMP_UH at the bottom of FIG. 4A for the integral operation. Of course, it can also be taken only a lower-half of the waveform for the integral operation. In addition, it is also possible to conduct the signal sampling or extracting only for a small period of time (i.e., the signal extraction period) during the transmission of the electricity signal is interrupted. The real-time result of the integral operation is shown by a curve L_INT at the bottom of FIG. 4A. Although a real-time integral operation is not necessary, the real-time integral results can also be used to carry out a real-time judgment on whether there is a foreign object nearby. Please refer to FIG. 4A (without a foreign object) and FIG. 4B (with a foreign object). When a foreign object is detected during the wireless power transfer, its attenuation of the oscillation waveform will become more significant, and a real-time change of the slope of the integrated average value will also become more significant.

In terms of obtaining the oscillation frequency, the oscillation waveform Q_COMP (indicated by a dotted line) can be processed to obtain a corresponding oscillation frequency extracted waveform L_PERIOD. The period of the oscillation frequency extracted waveform L_PERIOD is basically consistent with the period of the oscillation waveform Q_COMP. The frequency calculated from the oscillation frequency extracted waveform L_PERIOD can be used to represent the oscillation frequency of the oscillation waveform Q_COMP.

The control circuit 28 of the power transmitter 20 determines whether there is a foreign object approaching the power transmitter 20 during the wireless power transfer (e.g., whether there is a foreign object placed on or nearby the power transmitter 20) based on the integrated average value and the oscillation frequency. In detail, the control circuit 28 may compare the integrated average value with at least a first threshold and compare the oscillation frequency with at least a second threshold to determine whether the object exists during the wireless power transfer. The first threshold and the second threshold may be determined based on an integrated average value and an oscillation frequency of an oscillation waveform resulted when there is no foreign object and power receiver (RX) placed nearby during the wireless power transfer, respectively. These thresholds may also be set based on empirical values obtained from experiments. For example, if the integrated average value calculated from a measured oscillation waveform during the transmission of the electricity signal is temporarily interrupted (i.e., the period T_interrupt) falls in a first threshold range (which may at least include the first threshold), it can be determined that there is a foreign object approaching the power transmitter 20 during the wireless power transfer. If the oscillation frequency estimated from a measured oscillation waveform during the transmission of the electricity signal is temporarily interrupted (i.e., the period T_interrupt) does not fall in a second threshold range (which may at least include the second threshold), that is, the oscillation frequency does not change significantly, it can be determined that the object approaching the power transmitter 20 during the wireless power transfer is a foreign object; and if the oscillation frequency estimated from a measured oscillation waveform falls in the second threshold range, that is, the oscillation frequency changes significantly, it can be determined that the object approaching the power transmitter 20 during the wireless power transfer may be a coil-like foreign object.

Therefore, the power transmitter 20 in the embodiments of the present application can detect whether there is a foreign object and/or a coil-like foreign object nearby during the wireless power transfer and stop the undergoing power supply if a foreign object is detected.

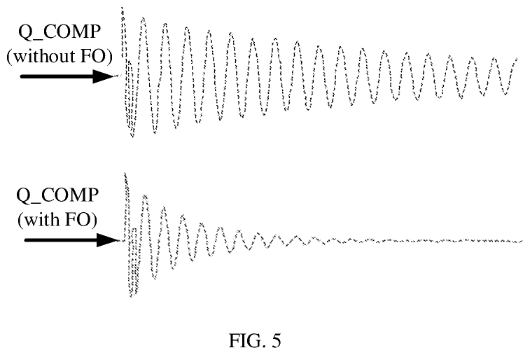

As shown in FIG. 5, when there is a foreign object (e.g., a coin) approaching the power transmitter 20, the amplitude of the oscillation waveform will be attenuated significantly, and its attenuation will be significantly greater than that of the oscillation waveform resulted when there is no foreign object nearby.

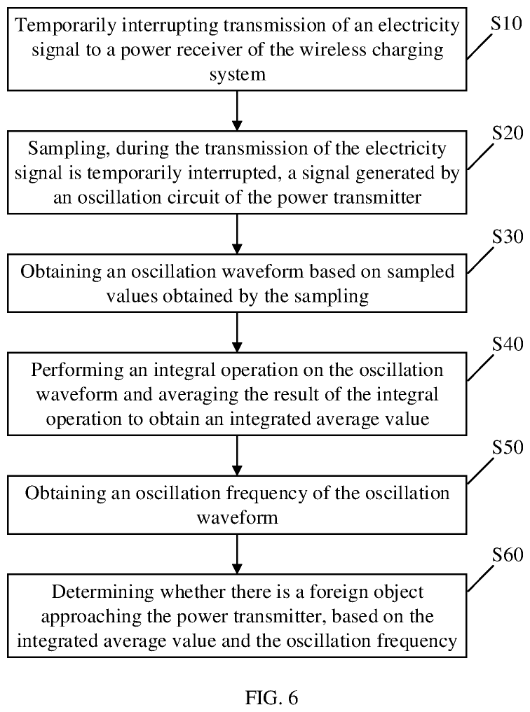

FIG. 6 is a flowchart of an object detecting method according to an embodiment of the present application. Please refer to FIG. 2 and FIG. 6. The method of foreign object detection in the embodiment of the present application includes the following steps:
Step S10: temporarily interrupting transmission of an electricity signal to a power receiver of the wireless charging system. During the wireless power transfer, it is possible to periodically temporarily interrupt the transmission of the electricity signal at intervals and detect whether a foreign object is approaching during the brief interruption. During the wireless power transfer, i.e., during the power transmitter 20 supplies power to the power receiver, the inverter 22 will persistently generate the inverter output waveform (V_{sw}). In this step, the control circuit 28 can control the inverter 22 to temporarily disconnect from a power supply for a short period of time (i.e., during the transmission of the electricity signal is temporarily interrupted) to conduct the detection on whether there is a foreign object approaching the power transmitter 20.
Step S20: sampling, during the transmission of the electricity signal is temporarily interrupted, a signal (e.g., voltage signal) generated by an oscillation circuit of the power transmitter. Specifically, the control circuit 28 can control the inverter 22 to persistently generate the inverter output waveform (V_{sw}) to charge the power receiver, and then disconnect the inverter 22 from a power supply during the transmission of the electricity signal is temporarily interrupted. The signal sampling circuit 26 samples the signal generated at the time by the oscillation circuit 24.
Step S30: obtaining an oscillation waveform based on sampled values obtained by the sampling. The sampled values obtained by the signal sampling circuit 26 during the transmission of the electricity signal is temporarily interrupted can be sent to the control circuit 28, or the sampled values can be stored in a buffer (not shown) and then the control circuit 28 reads the stored sampled values from the buffer (not shown) to obtain an oscillation waveform. This oscillation waveform is a damping oscillation waveform.
Step S40: performing an integral operation on the oscillation waveform and averaging the result of the integral operation to obtain an integrated average value. In an embodiment, referring to FIG. 3A, during the transmission of the electricity signal is temporarily interrupted, the control circuit 28 can obtain an integral result by calculating an area between a peak curve L formed by a first signal peak value V1 corresponding to a first time point t1 in the oscillation waveform and a second signal peak V2 corresponding to a second time point t2 in the oscillation waveform and a reference voltage V_{R}, and the integral result is averaged based on time to obtain the integrated average value. In another embodiment, referring to FIG. 3B, during the transmission of the electricity signal is temporarily interrupted, the control circuit 28 may obtain an integral result by calculating an area between all signal waveforms between a first time point t1 and a second time point t2 in the oscillation waveform and a reference voltage V_{R}, and the integral result is averaged based on time to obtain the integrated average value.
Step S50: obtaining an oscillation frequency of the oscillation waveform. Referring to FIG. 3C, during the transmission of the electricity signal is temporarily interrupted, the control circuit 28 can obtain the oscillation frequency by calculating an average of time length occupied by all of signal waveforms between a first time point t1 and a second time point t2 in the oscillation waveform.
Step S60: determining whether there is a foreign object approaching the power transmitter 20, based on the integrated average value and the oscillation frequency. The control circuit 28 may compare the integrated average value with at least a first threshold and compare the oscillation frequency with at least a second threshold to determine whether there is a foreign object approaching the power transmitter 20 during the wireless power transfer. For example, it is possible to determine whether a foreign object exists during the wireless power transfer based on whether the integrated average value falls in a first threshold range. Alternatively, it is possible to determine whether the object approaching the power transmitter 20 during the wireless power transfer is a coil-like foreign object based on a determination on whether the oscillation frequency falls in a second threshold range.

In the method of foreign object detection and the power transmitter of the embodiments of the present application, transmission of an electricity signal from the power transmitter to the power receiver of the wireless charging system is temporarily interrupted during wireless power transfer, and a damped oscillation waveform generated by the oscillation circuit of the power transmitter is sampled during the transmission of the electricity signal is temporarily interrupted. An integral operation is performed on the sampled oscillation waveform to obtain the integrated average value, and an estimation is conducted to obtain the oscillation frequency of the oscillation waveform. Then, the integrated average value and the oscillation frequency are based in determining whether there is a foreign object approaching the power transmitter, during the power transmitter supplies power electricity. Different from the conventional method, i.e., calculating a value of Q factor of the oscillation waveform, the present application can improve the conventional method in which the accuracy of the value of Q factor is affected by interference by noise or a deviation on extracted values, and this causes a problem in determining whether there is a foreign object approaching the power transmitter. Therefore, the present application can effectively improve the accuracy of determining whether there is a foreign object approaching the power transmitter during wireless power transfer.

While the preferred embodiments of the present application have been illustrated and described in detail, various modifications and alterations can be made by persons skilled in this art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. A method of foreign object detection, for detecting whether there is a foreign object approaching a power transmitter in a wireless charging system during the power transmitter supplies power electricity, the method comprising:
utilizing a control circuit to temporarily interrupt transmission of an electricity signal to a power receiver of the wireless charging system;
utilizing a signal sampling circuit to sample, during the transmission of the electricity signal is temporarily interrupted, a signal generated by an oscillation circuit of the power transmitter;
utilizing the control signal to obtain an oscillation waveform based on sampled values obtained by sampling the signal by the signal sampling circuit;
utilizing the control circuit to perform an integral operation on the oscillation waveform and average the result of the integral operation to obtain an integrated average value;
obtaining an oscillation frequency of the oscillation waveform; and
determining whether the foreign object exists, based on the integrated average value and the oscillation frequency.

2. The method of foreign object detection of claim 1, wherein the step of obtaining the integrated average value comprises:
obtaining a first signal peak value at a first time point in the oscillation waveform;
obtaining a second signal peak value at a second time point in the resonant waveform;
obtaining a peak curve based on the first signal peak value and the second signal peak value; and
performing the integral operation based on the peak curve and a reference voltage, and averaging the result of the integral operation based on a difference between the first time point and the second time point to obtain the integrated average value.

3. The method of foreign object detection of claim 2, wherein the result of the integral operation is represented by an area between the peak curve and the reference voltage.

4. The method of foreign object detection of claim 1, wherein the step of obtaining the integrated average value comprises:
obtaining a first time point corresponding to a first signal peak;
obtaining a second time point corresponding to a second signal peak; and
performing the integral operation on all of signal waveforms between the first time point and the second time point, and averaging the result of the integral operation based on a difference between the first time point and the second time point to obtain the integrated average value.

5. The method of foreign object detection of claim 4, wherein the result of the integral operation is represented by a sum of areas between all of the signal waveforms between the first time point and the second time point and a reference voltage.

6. The method of foreign object detection of claim 1, wherein the step of obtaining the oscillation frequency comprises:
obtaining a first time point corresponding to a first signal peak;
obtaining a second time point corresponding to a second signal peak; and
summing the time occupied by each of signal waveforms between the first time point and the second time point and averaging based on the sum, and converting the obtained result into a frequency to obtain the oscillation frequency.

7. The method of foreign object detection of claim 1, wherein the step of determining whether the foreign object exists comprises:
comparing the integrated average value with at least a first threshold and comparing the oscillation frequency with at least a second threshold to determine whether the foreign object exists.

8. The method of foreign object detection of claim 1, wherein the control circuit obtains the integrated average value and the oscillation frequency based on a scaled-down version of the oscillation waveform.

9. The method of foreign object detection of claim 1, wherein the control circuit obtains the integrated average value and the oscillation frequency based on an upper-half or a lower-half of the oscillation waveform.

10. The method of foreign object detection of claim 1, wherein the control circuit obtains the integrated average value and the oscillation frequency based on the oscillation waveform within a signal extraction period during the transmission of the electricity signal is temporarily interrupted.

11. A power transmitter in a wireless charging system, comprising:
a control circuit, configured to temporarily interrupt transmission of an electricity signal to a power receiver of the wireless charging system; and
a signal sampling circuit, coupled to the control circuit, configured to sample, during the transmission of the electricity signal is temporarily interrupted, a signal generated by an oscillation circuit of the power transmitter,
wherein the control circuit is further configured to:
obtain an oscillation waveform based on sampled values obtained by sampling the signal by the signal sampling circuit;
perform an integral operation on the oscillation waveform and average the result of the integral operation to obtain an integrated average value;
obtain an oscillation frequency of the oscillation waveform; and
determine whether there is a foreign object approaching the power transmitter, based on the integrated average value and the oscillation frequency.

12. The power transmitter of claim 11, wherein the control circuit is configured to:
obtain a first signal peak value at a first time point in the oscillation waveform;
obtain a second signal peak value at a second time point in the resonant waveform;
obtain a peak curve based on the first signal peak value and the second signal peak value; and
perform the integral operation based on the peak curve and a reference voltage, and average the result of the integral operation based on a difference between the first time point and the second time point to obtain the integrated average value.

13. The power transmitter of claim 12, wherein the result of the integral operation is represented by an area between the peak curve and the reference voltage.

14. The power transmitter of claim 11, wherein the control circuit is configured to:
obtain a first time point corresponding to a first signal peak;
obtain a second time point corresponding to a second signal peak; and
perform the integral operation on all of signal waveforms between the first time point and the second time point, and average the result of the integral operation based on a difference between the first time point and the second time point to obtain the integrated average value.

15. The power transmitter of claim 14, wherein the result of the integral operation is represented by a sum of areas between all of the signal waveforms between the first time point and the second time point and a reference voltage.

16. The power transmitter of claim 11, wherein the control circuit is configured to:
obtain a first time point corresponding to a first signal peak;
obtain a second time point corresponding to a second signal peak; and
sum the time occupied by each of signal waveforms between the first time point and the second time point and average based on the sum, and convert the obtained result into a frequency to obtain the oscillation frequency.

17. The power transmitter of claim 11, wherein the control circuit is configured to:
compare the integrated average value with at least a first threshold and compare the resonant frequency with at least a second threshold to determine whether there is a foreign object approaching the power transmitter.

18. The power transmitter of claim 11, wherein the control circuit obtains the integrated average value and the oscillation frequency based on a scaled-down version of the oscillation waveform.

19. The power transmitter of claim 11, wherein the control circuit obtains the integrated average value and the oscillation frequency based on an upper-half or a lower-half of the oscillation waveform.

20. The power transmitter of claim 11, wherein the control circuit obtains the integrated average value and the oscillation frequency based on the oscillation waveform within a signal extraction period during the transmission of the electricity signal is temporarily interrupted.
